(19) United States
(12) Patent Application Publication
(10) Pub. No.: US 2003/0135864 A1
(43) Pub. Date: Jul. 17, 2003

(54) DIGITAL DECODER OF A TRANSMISSION SYSTEM

(76) Inventor: ULRICH BARTH, MUNCHINGEN (DE)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 09/082,184

(22) Filed: May 20, 1998

(30) Foreign Application Priority Data
May 31, 1997 (DE) 19722915.8

(51) Int. Cl. H04N 7/16; H04H 9/00; H04N 7/173; G06F 3/00; G06F 13/00

(52) U.S. Cl. 725/100; 725/131

(57) ABSTRACT

The habits of users are to be determined in a service-on-demand system in order to analyze and optimize the menu control. A digital decoder (STB) is employed having a control device (P) which can be controlled by a received timing signal. The control device is adapted to capture input sequences from a user which include a plurality of commands together with the time when the individual commands were entered, and to store the input sequences in a write/read memory (MEMO). Alternatively, the timing signal can be used to determine the time interval between the individual commands. These time intervals are then stored instead of the actual input times. The stored packets, together with packets received from a plurality of digital decoders, can also be transmitted telemetrically to a server for processing.

### BACKGROUND OF THE INVENTION

1. Technical Field

The invention relates to a digital decoder of a transmission system, in particular a service-on-demand system. Such a digital decoder, also referred to as set-top box, comprises, among others, a control device, e.g., a processor or a microprocessor, and a write/read memory, e.g., a RAM (RAM=random access memory) or a nonvolatile memory, e.g., a so-called flash memory.

2. Discussion of Related Art

A set-top box is described, for example, in the article “Standard For Set-Top Boxes”, published in the journal Funkschau, 17/1995, pp. 42 to 44. A set-top box forms an interface between terminals, such as a television set, and a server, for example a video-on-demand server offering video movies, which can be selected telemetrically by a user and which are subsequently transmitted telemetrically to the user via a transmission network. The set-top box is adapted to decode the received video movies and to process the video movies, e.g., to convert the video movies received in digital form into an analog form, and to transmit the processed video movies to the television set. As a control device, the set-top box comprises a processor and a RAM used as an intermediate memory. The set-top box is also adapted to receive the commands transmitted by the user to the set-top box via, for example, an infrared remote control, to process these commands and to transmit the commands to the server. The commands include the user requests, e.g., a menu selection for obtaining a summary of the offered video movies, another menu selection for locating a more specific video movie offer, for selecting a video movie and for ordering a video movie.

In such a service-on-demand system, it is desirable to evaluate the user habits in order to analyze and optimize the menu control. This is described, for example, in the article “Software Architectures For Interactive Digital Decoders” in the journal Fernseh- und Kino-Technik, No. 3/1996, pp. 92 to 102. The following questions will then have to be answered; for example: How quickly does a user complete a prescribed task? or: How many errors does the average user make? or: How long does it take the user to get reacquainted with the system after the system was not in use for several days? Answers to these questions are customarily obtained by questioning a sample population, which is very expensive and can lead to subjective results.

It is known from WO 94/14280 to store video movies selected by the user in the set-top box of the user and to retrieve the video movies at an appropriate time from a server by a polling method. However, only those video movies actually selected and ordered by the user can be monitored with this method. It is also not possible to determine, how the user arrived at his/her selection. Consequently, the questions mentioned above cannot be answered by analyzing the user interface and the menu selections.

### SUMMARY OF INVENTION

It is therefore an object of the invention to determine the user habits of a service-on-demand system in order to be able to analyze and to subsequently optimize the menu selections and/or the user interface.

According to a first aspect of the invention, a digital decoder (STB) of a transmission system, in particular a service-on-demand system, with a control device (P) and a write/read memory (MEMO), is characterized in that the control device (P) is controllable via a received timing signal and that the control device (P) is for capturing a user input sequence comprising a plurality of individual commands, for determining with the help of the timing signal respective input times of the individual commands and for controlling the write/read memory (MEMO) for storing the user input sequences together with the respective input times of the individual commands in the form of packets.

According to a second aspect of the invention, a digital decoder (STB) of a transmission system, in particular a service-on-demand system, with a control device (P) and a write/read memory (MEMO), is characterized in that the control device (P) is controllable via a received timing signal and that the control device (P) is for capturing a user input sequence comprising a plurality of individual commands, for determining with the help of the timing signal time intervals between the individual commands and for controlling the write/read memory (MEMO) for storing the user input sequences together with the respective time intervals between the individual commands in the form of packets.

The object is thus solved according to the invention by a digital decoder according to the first or second aspects of the invention. All commands from the user together with the respective input times or the time separation between the individual commands are determined and stored in the digital decoder. The user habits can thereby be determined in detail and as a function of time. Because the subjective response of test persons is eliminated and instead input sequences from a plurality of users of an existing service-on-demand system are evaluated under actual operating conditions, an objective and representative analysis is possible.

A particularly preferred embodiment of the invention comprises a transmitting device capable of transmitting the stored input sequences to the server. The user habits can then be determined telemetrically, saving time and expenses. The user habits are evaluated only for statistical purposes. To ensure anonymity of the user, the address of the respective digital decoder can be suppressed during transmission of the input sequences. Alternately, the server can consecutively telemetrically read out all the servers and delete the addresses from the received signals.

### BRIEF DESCRIPTION OF THE DRAWING

FIG. 1 is a schematic diagram of a digital decoder of the invention.

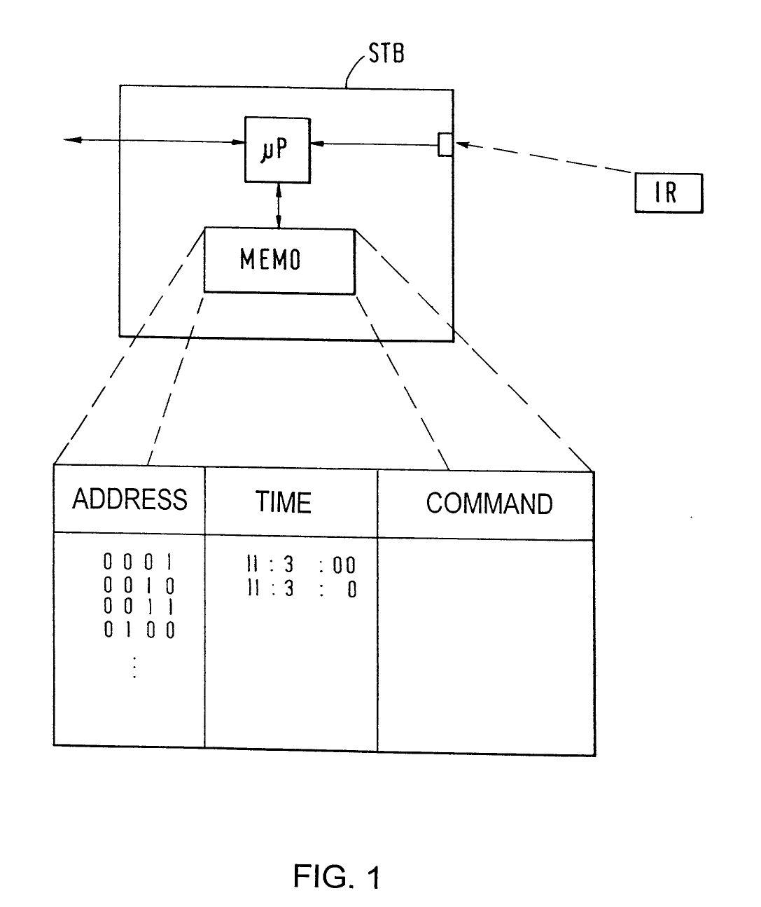

FIG. 2 shows a set top box in more detail.

### DETAILED DESCRIPTION OF PREFERRED EMBODIMENTS

The digital decoder STB, also referred to as set-top box, comprises all the elements found in a conventional digital decoder, as described, for example, in the article “Standard For Set-Top Boxes”, published in the journal Funkschau, 17/1995, pp. 42 to 44. Included are, e.g., a tuner, a demodulator, a decoder, a control device which may be a signal processor P which may include a microprocessor (μP) representing a control device and a RAM representing a write/read memory MEMO.

The digital decoder serves as the interface between a television set and a server, e.g., a video-on-demand server offering video movies which can be selected by a user telemetrically via a menu displayed on the television set and which are subsequently transmitted telemetrically to the user via a transmission network. The user makes the selection with an infrared remote control IR capable of transmitting commands to the digital decoder STB. The commands entered by the user can be viewed as an input sequence and range from commands for switching the digital decoder STB on to switching the decoder off again. The commands allow the user to search for, select, order, view and possibly forward and/or rewind a video movie.

The control device P is programmed so as to be able to acquire from a user input sequences comprising a plurality of commands. The individual commands are processed under the control of the control device P, e.g., in an encoder and a protocol converter, and then transmitted the server. In addition, all commands together with the time of the day associated with these commands are stored in the write/read memory MEMO in the form of packets comprising several addresses of an address range. The commands are stored with their respective input times in a form resembling a table. The write/read memory MEMO uses a separate address range for each input sequence. The first command input is entered, for example, at 11:30:00 o'clock. The time 11:30:00 and the type of command is then stored in the write/read memory MEMO in memory address 0001, e.g., 000 001, wherein 000 represents the menu level, i.e., the 0^{th} level of eight levels and 001 represents the selection number 1 of eight possible selection numbers in level 0. The second command input is entered, for example, at 11:31:00 o'clock. The time 11:31:00 and the type of command is then stored in the write/read memory MEMO in memory address 0010, e.g., 001 100, wherein 001 represents the menu level, i.e., the first level of eight levels and 100 the selection number 4 of eight possible selection numbers in the first level. The third command input is entered, for example, at 11:32:10 o'clock. The time 11:32:10 and the type of command is then stored in the write/read memory MEMO in memory address 0011, e.g., 010 111, wherein 010 represents the menu level, i.e., the second level of eight levels and 111 the selection number 8 of eight possible selection numbers in the second level. The fourth command input is entered, for example, at 11:35:36 o'clock. The time 11:35:36 and the type of command is then stored in the write/read memory MEMO in memory address 0100, e.g., 011 101, wherein 011 represents the menu level, i.e., the third level and 101 the selection number 5 of eight possible selection numbers in the third level.

The address ranges used to store respective individual input sequences are administered in a file manager which is controlled by the control device P, and can be read out at any time.

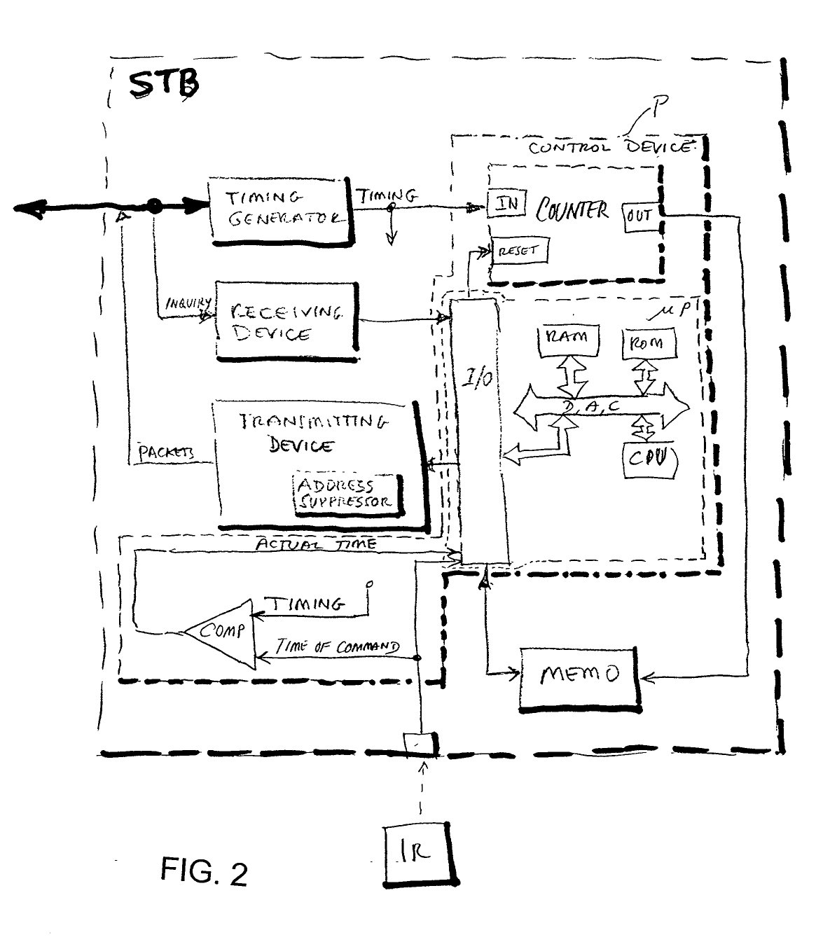

The digital decoder also includes a receiving device as shown in FIG. 2 for receiving signals which include an inquiry or request to telemetrically read the write/read memory MEMO, and a transmitting device for transmitting the stored packets. The stored input sequences can be retrieved telemetrically, e.g., by the server which transmits an inquiry together with its address to the respective digital decoder STB. In the receiving device, it is checked if the received signal is intended for the respective digital decoder STB by comparing the received address with the address of the decoder STB. If these addresses agree with each other, then the receiving device transmits the inquiry to the control device P, which detects in a file manager the input sequences stored until the time the inquiry is made and subsequently transmits these input sequences to the transmitting device. The transmitting device then transmits the input sequences together with the address of the digital decoder STB to the server.

Instead of querying the server, a transmitting device can also be provided for transmitting the stored packets containing the input sequences, wherein the transmitting device is adapted to suppress the transmission of the address of the digital decoder STB during the transmission of the packets. This has the advantage that the server does not have to query all the digital decoders STB. This can be more time-efficient, especially when some digital decoders STB have been sitting idle for extended periods of time, and it would be wasteful to query them at regular time intervals, e.g., once per week, since there are no newly stored input sequences to report. The digital decoder STB therefore transmits the stored packets to the server automatically, e.g., after a predetermined time period, e.g., once per month, if new packets exist. If no new packets exist, then nothing is transmitted. The anonymity of the user is thereby optimally protected. The invention can also be used with a transmission system which does not have a backward channel to the server, such as video text (BTX). The stored input sequences are then transmitted to the server, for example, via mail.

The input sequences can also be stored together with the time intervals between the individual commands instead of with the actual input times. This saves memory space, since only the difference between the actual times and not the absolute time values have to be stored.

For this purpose, the control device P has, e.g., a counter which determines with the help of the timing signal the time intervals between the individual commands. The counter comprises: a counter input receiving the timing signal; an output whose value is read out each time a command is received, for determining the time intervals; and a reset input for resetting the counter to zero each time a command is received and after the output value has been read out.

The control device P of FIG. 2 is shown with both a counter and a microprocessor (μP) which together interface with the write/read memory MEMO. The microprocessor is shown with an input/output (I/O) port connected to a data, address, and control bus (D,A,C) which is also shown connected to a random access memory (RAM), a read only memory (ROM) and a central processing unit (CPU). It should be realized that the write/read memory MEMO could be part of the memory of the microprocessor, such as the RAM, instead of being a separate device.

The input sequences of the user together with the respective time intervals between the individual commands are then stored in the form of packets, which is similar to the table-like storage described above. For example, in the a fore described example the time 000 000000 can be stored the at the address 0001 wherein 000 indicates the number of minutes and 000000 the number of seconds. If it is necessary to record the exact time when an input is received, then the actual time 11:30:00 can also stored at this address instead. The time interval between command 1 and command 2 is then stored at the address 0010. The time interval is one minute so that the time 001 000000 is stored. The time interval between command 2 and command 3 is subsequently stored at the address 0011. The time interval is one minute and ten seconds so that the time 001 001010 is stored. The time interval between command 3 and command 4 is then stored at the address 0100. The time interval is three minutes and twenty-six seconds so that the time 010 011010 is stored.

Although the invention has been shown and described with respect to a best mode embodiment thereof, it should be understood by those skilled in the art that the foregoing and various other changes, omissions and additions in the form and detail thereof may be made therein without departing from the spirit and scope of the invention.

1. Digital decoder (STB) of a transmission system, in particular a service-on-demand system, with a control device (P) and a write/read memory (MEMO), characterized in that
the control device (P) is controllable via a received timing signal and that the control device (P) is for capturing a user input sequence comprising a plurality of individual commands, for determining with the help of the timing signal respective input times of the individual commands and for controlling the write/read memory (MEMO) for storing the user input sequences together with the respective input times of the individual commands in the form of packets.

2. Digital decoder (STB) of a transmission system, in particular a service-on-demand system, with a control device (P) and a write/read memory (MEMO), characterized in that
the control device (P) is controllable via a received timing signal and that the control device (P) is for capturing a user input sequence comprising a plurality of individual commands, for determining with the help of the timing signal time intervals between the individual commands and for controlling the write/read memory (MEMO) for storing the user input sequences together with the respective time intervals between the individual commands in the form of packets.

3. Digital decoder (STB) according to claim 2, characterized in that the control device (P) has a counter comprising a counter input receiving the timing signal and an output wherein the value at the output is read each time a command is received in order to determine the time intervals, the counter further comprising a reset input for resetting the counter each time a command is received and after the output value has been read.

4. Digital decoder (STB) according to claim 1, characterized in that the timing signal indicates the actual time of the day and that in the control device (P) there is provided a comparator for comparing the time when a command is received, with the actual time of the day and for assigning to the respective command the so determined time of the day.

5. Digital decoder (STB) according to claim 1, characterized in that there is provided a timing generator for generating the timing signal and for transmitting the timing signal to the control device (P).

6. Digital decoder (STB) according to claim 1, characterized in that there are provided a receiving device for receiving signals which comprise an inquiry for telemetric reading of the write/read memory (MEMO), and a transmitting device for transmitting the stored packets.

7. Digital decoder (STB) according to claim 1, characterized in that there is provided a transmitting device for transmitting the stored packets, wherein the transmitting device is capable of suppressing transmission of the address of the digital decoder (STB) during the transmission of the packets.

8. Digital decoder (STB) according to claim 2, characterized in that there is provided a timing generator for generating the timing signal and for transmitting the timing signal to the control device (P).

9. Digital decoder (STB) according to claim 2, characterized in that there are provided a receiving device for receiving signals which comprise an inquiry for telemetric reading of the write/read memory (MEMO), and a transmitting device for transmitting the stored packets.

10. Digital decoder (STB) according to claim 2, characterized in that there is provided a transmitting device for transmitting the stored packets, wherein the transmitting device is capable of suppressing transmission of the address of the digital decoder (STB) during the transmission of the packets.
